(19) United States
(12) Patent Application Publication
(10) Pub. No.: US 2015/0206243 A1
(43) Pub. Date: Jul. 23, 2015

(54) METHOD AND SYSTEM FOR MEASURING FINANCIAL ASSET PREDICTIONS USING SOCIAL MEDIA

(71) Applicant: Martin Camins, Waterloo (CA)

(72) Inventor: Martin Camins, Waterloo (CA)

(21) Appl. No.: 14/584,111

(22) Filed: Dec. 29, 2014

Related U.S. Application Data
(60) Provisional application No. 61/921,138, filed on Dec. 27, 2013.

(51) Int. Cl. G06Q 40/06; G06Q 50/00

(52) U.S. Cl. CPC G06Q 40/06; G06Q 50/01

(57) ABSTRACT

A method according to an exemplary aspect of the present disclosure includes, among other things, storing a prediction of an individual on a computing device. The prediction is a prediction of a value of a financial asset over a time period. The method further includes comparing the prediction to the actual price of the financial asset over the time period, and generating a rating for the individual based on the relationship between the prediction and actual price. The method is performed using a computing device, which may include at least one of a personal computer (such as a tablet, smartphone, or laptop) and a server.

### RELATED APPLICATIONS

This application claims the benefit of U.S. Provisional Application No. 61/921,138, filed Dec. 27, 2013, the entirety of which is herein incorporated by reference.

### BACKGROUND

A growing number of software and web-based applications available today are designed to gather financial data and information from a variety of sources in order to help individuals make informed investment decisions. Based on this information, individuals can identify trends, be alerted about important events that may impact financial markets and potentially obtain an advantage over other investors who do not utilize these technologies.

Most of these software tools, applications, and websites are able to gather a significant amount of data which then has to be filtered and deciphered by the user. Some of these tools filter the information based on selections by the user, so that the data becomes more meaningful. Some tools even allow alerts to be triggered based on a series of user defined rules using financial metrics, in order to enhance and automate the investment decision making process.

One area of financial data analysis that is starting to gain traction but has not been fully exploited is in the area of social media analytics for the financial sector. There are several reasons for the popularity of the use of social media within financial markets. Social media provides a simple and effective way for an individual to communicate to a large number of people in real-time. Since financial assets are often news driven, social media is an ideal communications platform for the dissemination of financial information or opinion and can potentially provide investors with significant benefits.

There are websites that allow a user to search social media for specific financial information but there are few tools available to analyze the extensive amount of information sufficiently to make it consistently useful. There is also a scarcity of solutions that can take action (such as triggering an event) based on a combination of specific financial and social media data.

As an example, investors who wish to see the opinions and views of other investors on specific financial assets (stocks, bonds, currencies, real estate etc.) can receive alerts or search websites for social media information such as blogs, tweets, opinions and reports on specific equities or securities. While this can be beneficial, it requires users to filter and/or decipher the information manually, which can be confusing, time-consuming and even frustrating. It can be problematic due to the sheer amount of social media chatter available on each individual security, particularly those that are widely held or discussed. The information is often overwhelming and can become virtually unusable for the purposes of financial decision making.

### SUMMARY

A method according to an exemplary aspect of the present disclosure includes, among other things, storing a prediction of an individual on a computing device. The prediction is a prediction of a value of a financial asset over a time period. The method further includes comparing the prediction to the actual price of the financial asset over the time period, and generating a rating for the individual based on the relationship between the prediction and actual price. The method is performed using a computing device, which may include at least one of a personal computer (such as a tablet, smartphone, or laptop) and a server.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The drawings can be briefly described as follows:

FIG. 1 is a flow chart illustrating an example method.

FIG. 2 schematically illustrates an example system.

FIG. 3 is a flow chart illustrating the method of this disclosure as it relates to a prediction from an external contributor.

FIG. 4 is a flow chart illustrating the method of this disclosure as it relates to a prediction from an internal contributor.

### DETAILED DESCRIPTION

The present disclosure relates to a method 10 and system 11 comprising a cloud-based, web-centric software system that accesses, stores, analyzes and aggregates financial data and social media information through algorithms and analytics. Contributors from Twitter, for example, send a message (e.g., a tweet) containing a prediction. The system searches for keywords and symbols (such as a hashtag, “#,” or a dollar sign, “$”) within the message indicating a prediction. This prediction is stored and is compared to actual data over various time periods, and a rating is assigned to the contributor based on the accuracy of the prediction.

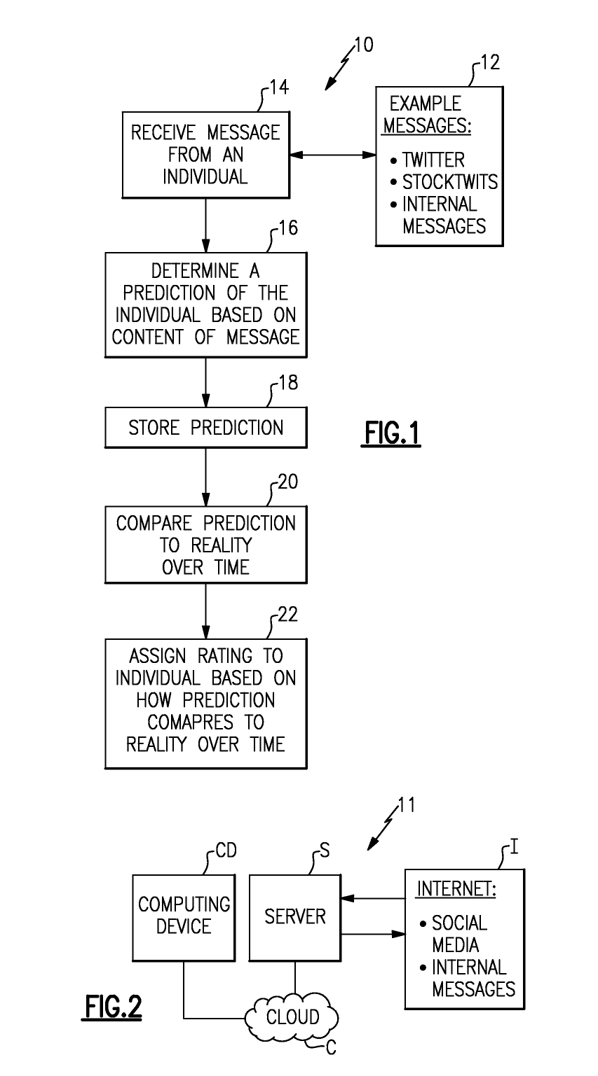

With reference to FIG. 1, the method 10 classifies anyone that authors certain messages 12, such as social media messages, that are deemed to have made a prediction or call on the future movement of a specific financial asset as a contributor. A contributor can either be external or internal. An external contributor is an individual that provides predictive social media information without any knowledge of the system described in the present disclosure. At 14, the method accesses this data from a variety of social media data sources. An internal contributor is a user of the system that also contributes financial social media information internal to the system.

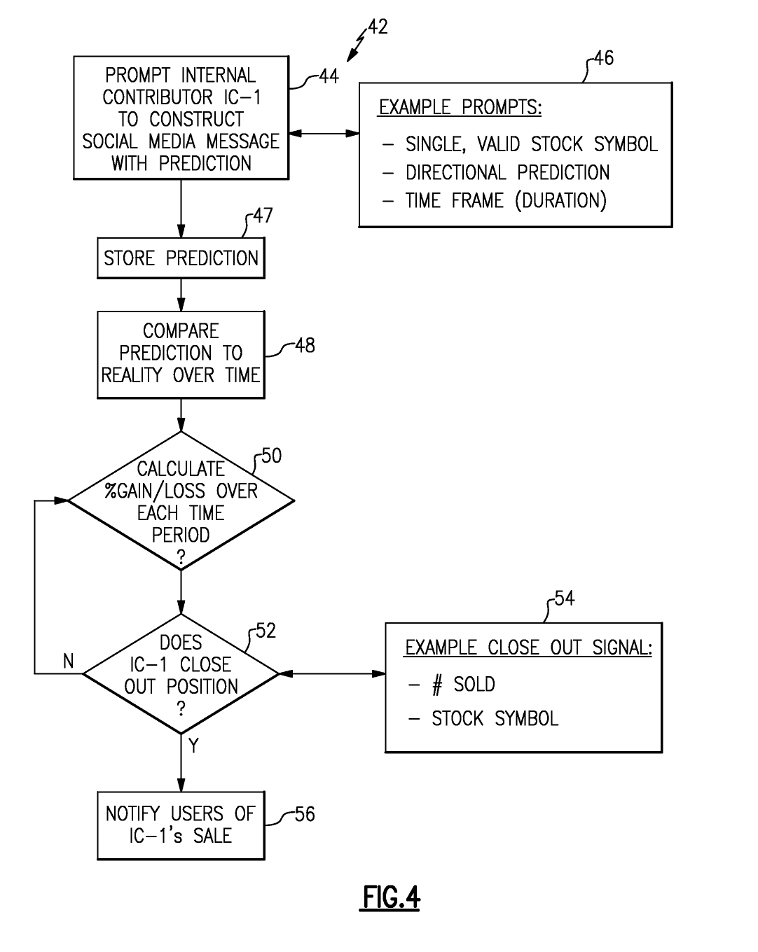

The method 10 utilizes proprietary algorithms to analyze the financial performance of the assets identified by both internal and external contributors over designated time frames. The algorithm used to analyze assets identified by external contributors may be more complex than for internal contributors. In part, the added complexity is because messages from external contributors requires an additional step of looking for identifiers (e.g., keywords and symbols) within the data that indicate the prediction of the contributor and whether they are predicting or calling for a particular asset to increase or decrease in price or value from the time they publicized the information. This may involve complex natural language processing and extensive data analytics to accurately determine whether the social media message is indeed a valid financial asset prediction. This is explained below with reference to FIG. 3. In one example of this disclosure (e.g., FIG. 4), an internal contributor will be prompted by the system to indicate specifically in which direction they believe an asset will move from the time they provide the information so that there is no interpretation required.

At 16, the method 10 looks for and uses special symbols within a social media message, such as a hash tag (“#”) in a tweet for instance. Hash tag preceded words such as #BOUGHT or #LONG followed by dollar sign preceded stock symbols could indicate that a contributor has just purchased the specified underlying asset. For example, a tweet containing “#BOUGHT $AAPL” could signify that the contributor believes Apple stock will rise in the future. Likewise, #SOLD or #SHORT $AAPL could signify that the contributor believes Apple stock will drop in the future. Internal contributors would be prompted by the system to include the predictive direction of the underlying asset. Alternative keywords could also be used such as #BUY, #SELL, #HIGHER, #LOWER, #UP, #DOWN, etc.

The method would also look for and utilize duration indicators. Examples of duration indicators could be #SHORT-TERM, #SWING, #MEDIUM-TERM, #TRADE, #INVESTMENT and #LONG-TERM for instance. Again, internal contributors would be prompted by the system to include the duration indicator in their prediction. One embodiment of the methodology would associate set time frames to each duration indicator. For instance, a contributor that designates their prediction as #SWING or #TRADE would only have that message's performance measured over a 1 week, 1 month and 3 month time frames, and a #LONG-TERM or #INVESTMENT contribution might be measured over a 3 month and 1 year time frame.

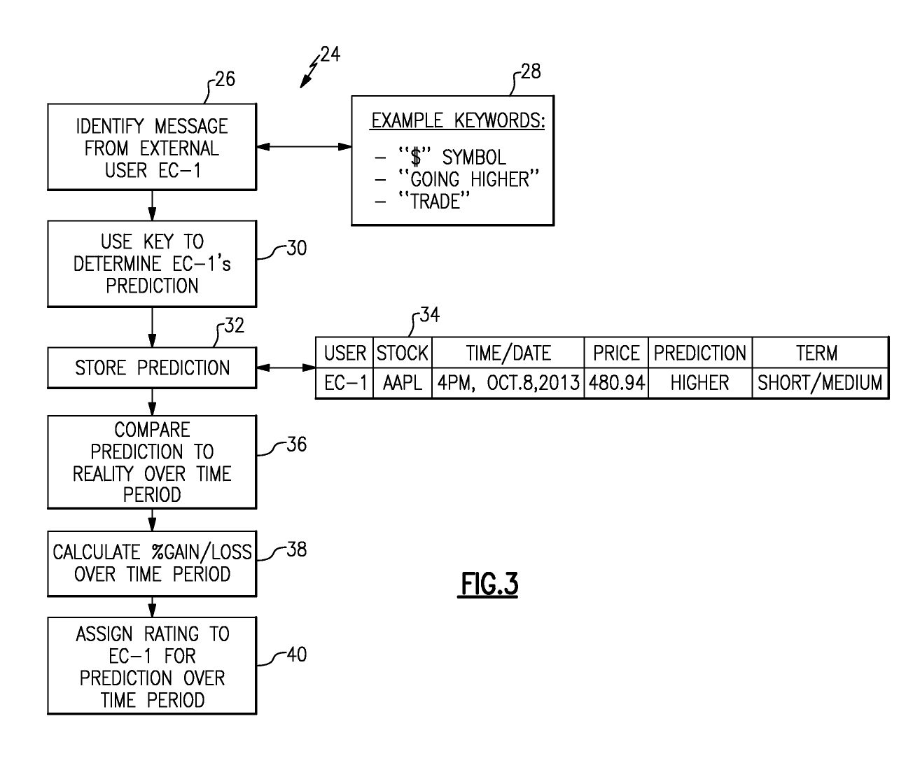

The method 10 then saves the information provided by contributors, at 18, to a centralized data store (such as the server S; see FIG. 2) with the current price or value of the identified or underlying asset, along with a date and time stamp. The system S will then scan the data store on a continual basis and will save the future values of underlying assets identified by all contributors at designated time frames from when the original information was publicized. These can be both short and long term and would include fiscally relevant durations such as daily, weekly, monthly, quarterly and yearly time frames.

The method will also allow contributors to change their prediction at any time and would save this change in sentiment along with the current value of the underlying assets to the data store with date and time stamp.

At 20, the method 10 tracks the performance of assets identified by contributors over set or designated time frames, typically in terms of percentage gain or loss. The method can also assign specific levels of performance, at 22, to the contributor based on the amount of percentage gain or loss of each prediction annualized over a specified time frame. For instance, a gain of 0-10% could be a performance level of GOOD, 10-25% VERY GOOD, 25-50% GREAT, 50-100% EXCELLENT, 100%+ OUTSTANDING. The method can subsequently track the cumulative performance of all assets identified by each individual contributor and assign a rating to each contributor based on the degree and accuracy of their predictions. Subsequently, the method can then rank contributors based on their prediction ratings relative to one another over certain time periods.

Including to contribution performance, the method can also rank contributors based on other metrics or attributes including number of followers, amount of favorable reviews of their contributions etc., either separately or in combination.

As a result, users can now find or track (follow) contributors based on individual rankings that reflect their popularity and ability to predict future asset values. Through this methodology, the method essentially has the ability to track the performance of individual contributors over time.

Once contributor performance has been established, the method will allow users to search for or receive financial social media information from selected top performing contributors. The information can be further filtered down using additional user specified criteria including financial metrics. Common financial assets that are predicted by a number of top contributors will be identified so that users can find investible assets that are being recommended by the best performing contributors.

Users will now have a powerful and automated tool for discovering specific and relevant information to help them make informed decisions, based on a combination of selected financial metrics and real time recommendations from top performing contributors within the overall “crowd” (e.g., group) of contributors, regardless of whether those contributors are investment professionals or simply high performing individual investors.

The system can also be used to trigger events based on a combination of any of the criteria previously mentioned. This can include alerts, events or commands such as executing a trade within a stock brokerage trading platform when the criteria is met.

In addition to being used as a tool for financial information and triggering events, the system can also be utilized to provide a platform for competition through gamification. Users can compete against each other by contributing financial information with the goal of achieving high ratings and ranking based on their predictions. The gamification aspect of the system can assign different levels of achievement over time as a contributor provides more and more information, and reaches higher performance ratings. This can also include awards and prizes for high levels of achievement. Examples of achievement levels might be INTERN, NOVICE, TRADER, TOP-TRADER, SPECIALIST, ADVISOR, MARKET GURU, and ORACLE for instance.

The system would also be capable of automatically creating asset portfolios for each contributor based on the social media contributions they provide. Portfolios can then be tracked and displayed for informational or competitive purposes.

The system would also be capable of rating and ranking contributors based on demographic information such as age, gender and location, for those contributors willing to provide this information.

An alternate embodiment of the invention would be in the form of a self-contained software module that can be integrated into another software system such as an equity trading platform where the functionality outlined herein would be accessible through an API (Application Programming Interface).

Although not specifically detailed, the present invention includes any other embodiments that incorporate variations on the algorithms outlined herein, and/or which is designed to generate performance ratings based on financial social media analytics and/or is used to allow users of the system to find and use such performance ratings to trigger alerts or events.

The present invention also includes any other embodiment that uses said performance ratings and rankings as a training and/or competitive platform for individual users and contributors.

The present invention also includes embodiments that use financial metrics other than price or value.

The present invention also includes the analysis of non-financial social media information to determine performance ratings and contributor rankings and to create a platform for contributor competition and gamification. This might include but not be limited to social media predictions of outcomes for sporting events, economic indicators, elections, award shows etc.

As mentioned above, this disclosure (in one example) is embodied primarily on a server S (FIG. 2). In this example, the server S essentially mines the internet I (e.g., StockTwits, Twitter) in step 14 for messages from certain individuals (such as financial analysts) and continually tracks and stores real time stock prices at step 20. It should be understood that this disclosure may be embodied additionally or alternatively on a personal computing device CD such as a smart phone, tablet or personal computer.

The method 10 is performed by a computing device, which includes at least one of a personal computing device CD and the server S. The personal computing device CD is connected to the server S via a network (such as the cloud C) in one example.

It should be understood that the personal computing device CD may be in the form of a tablet, smartphone, portable or personal computer equipped with a screen, that may be a touchscreen in some examples. In one example, the personal computing device CD is equipped with a central processing unit (CPU) executing a software application loaded in program memory. The personal computing device CD also has a data store (or, database) that locally stores user data. Further, the server S also includes one or more software applications loaded in memory and executed by a CPU of the server S. Collected data can be stored on either the personal computing device CD or the server S and used for data mining and statistical analysis to provide commercially useful information.

With the above description as a backdrop, two examples of the system and method of this disclosure are provided below for illustrative purposes only. These examples

(“Example 1” and “Example 2”) may differ from the actual algorithms implemented by the system.

### Example 1

FIG. 3 is a flow chart 24 showing how the method 10 and system 11 of this disclosure would function relative to an external contributor. In the flow chart 24, an External Contributor EC-1 sends the following tweet using the Social Media site Twitter @ 4 pm, Oct. 8, 2013; “I believe $AAPL is going higher from here over the next few weeks for a trade.”

The system 11 captures this message, at 26, from the Twitter data feed. The system 11 is operable to use a plurality of identifiers (examples listed at 28) to identify the message as a financial tweet. In one example, the system identifies the tweet as a financial tweet based on the use of the “$” symbol preceding a valid stock symbol. In this case, $AAPL refers to the stock symbol for Apple Inc.

Additionally, in order to determine EC-1's prediction, at 30, the system 11 interprets the words “is going higher” as strong (versus weak) evidence that EC-1 is making a prediction Apple stock is going higher in the short to medium term based on the word “trade” also contained in the message.

The system 11 would save this tweet to a data store along with the date and time of the tweet, at 32. The system 11 would also determine the price of Apple stock at the time of the tweet and save that price in the same data record. For purposes of illustration, say the tweet was made at 4 PM on Oct. 8, 2013, and Apple stock had a price of $480.94 at the time. This example data record is shown at 34.

The system 11 then compares the stored data record 34 of the prediction to reality, over time, at 36. In this example, since the External Contributor EC-1 made a short to medium term prediction, the system 11 would determine the price of Apple stock on Oct. 15, 2013, one week after the prediction. In the example, the price had increased since the Oct. 8, 2013 prediction, to $498.68.

The system 11 then, at 38, calculates and saves the 1 week percentage gain of this predictive message which was 3.69% or 192% non-compounded annualized rate of return. The system would subsequently determine the price of Apple stock on Nov. 8, 2013, which in this example closed at $520.56 and calculate the 1 month percentage gain which was 8.24% or 99% non-compounded annualized.

Under this scenario, as shown at 40, External Contributor EC-1 would have one predictive contribution rating of EXCELLENT after 1 week and OUTSTANDING after 1 month. These ratings would be added to EC-1's overall collection of contribution ratings. The system would eventually calculate the return after 3 months (1 quarter) unless EC-1 sends a subsequent message indicating a change in sentiment.

The system would automatically add the financial asset AAPL to EC-1's portfolio showing the weekly, monthly and quarterly returns. Over time, the system would add percentage gains/losses for all predictive contributions within each duration category, and would rank contributor performance for each of the designated time frames. It would then display a sorted list of contributors in order of ranking based on their cumulative percentage gain for all of their contributions grouped by time duration. Users would then be able to view the top performing contributors within each time frame (weekly, monthly, quarterly and perhaps yearly).

### Example 2

While the example flow chart 24 of FIG. 3 relates to an External Contributor EC-1, FIG. 4 shows an example flow chart 42 as it relates to an Internal Contributor IC-1. In this example, the Internal Contributor IC-1 sends the following social media message, similar to a tweet, constructed from within the system 11 after market close on Nov. 20, 2013 “I #BOUGHT $AAPL for an #INVESTMENT.”

At 44, the system 11 prompted Internal Contributor IC-1 to ensure that he or she specified a single valid stock symbol, a directional prediction (#BOUGHT in this case) and a time frame (#INVESTMENT signifying long-term). Example prompts are shown at 46. The system 11 may assist the Internal Contributor IC-1 in constructing the message by presenting the Internal Contributor IC-1 with a plurality of fields. Alternatively, the Internal Contributor IC-1 could construct the message, and the system 11 would ask the Internal Contributor whether they intended to indicate that the stock would move in a particular direction during a particular time frame. The Internal Contributor IC-1 would either confirm the meaning of the message or modify the message as necessary.

As in the previous example, at 46 the system 11 saves the information from the message (e.g., prediction) with date, time stamp, direction, stock symbol, duration, and underlying stock price. The system 11 may then also send the message to other users that subscribe to IC-1's messages, and upload the message to Twitter if IC-1 approves.

As in the prior example, the system 11 would also calculate the quarterly and annual rates of return and assign a rating to this predictive contribution, as illustrated at 48 and 50. The system would automatically add the security AAPL to Internal Contributor IC-1's portfolio showing the quarterly and annual returns.

In this example, the system 11 will continue making these calculations unless Internal Contributor IC-1 closes out the position, at 52. At 54, an example message signaling a close out of a position includes keywords such as #SOLD and $AAPL, which indicates IC-1 has sold Apple stock. In that case, the system 11 will make note of the sale and stop calculating the gain and/or loss of the stock. Users that subscribe to IC-1's feed may also be notified of the sale, at 56, either through Twitter (if IC-1 approves) or via some other type of system alert or via email.

Again, as mentioned above, the present disclosure analyzes and filters through the vast amounts of social media information to uncover concise, relevant and useful data based on user specifications.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method, comprising:
storing a prediction of an individual on a computing device, the prediction being a prediction of a price of a financial asset over a time period;
comparing, using the computing device, the prediction to the actual price of the financial asset over the time period; and
generating a rating, using the computing device, for the individual based on the relationship between the prediction and actual price.

2. The method as recited in claim 1, wherein the user is assigned a favorable rating when the actual price of the financial asset over the time period is consistent with the prediction.

3. The method as recited in claim 1, wherein the user is assigned an unfavorable rating when the actual price of the financial asset over the time period is inconsistent with the prediction.

4. The method as recited in claim 1, wherein the computing device includes at least one of a tablet, a smartphone, a portable computer, a personal computer, and a server, and wherein the steps of the method are performed using the computing device.

5. The method as recited in claim 1, wherein the prediction is determined by identifying at least one keyword within a social media message.

6. The method as recited in claim 5, wherein the at least one keyword includes a stock symbol and a term indicative of whether that stock will increase or decrease in price over time.

7. The method as recited in claim 6, wherein the at least one keyword includes a term indicative of the duration associated with the prediction.

8. The method as recited in claim 1, wherein the prediction is determined by presenting the individual with at least one prompt.

9. The method as recited in claim 8, wherein the at least one prompt includes a field for the individual to enter a valid stock symbol, a field for the individual to enter a directional prediction for the stock symbol, and a field for the user to enter a time period.

10. The method as recited in claim 9, including constructing a social media message based on entries the individual enters into the fields.

11. The method as recited in claim 1, wherein the individual is assigned a level of achievement based on the accuracy of a plurality of predictions made by the individual.

12. A system, comprising:
a computing device configured to store a prediction of an individual, the prediction being a prediction of a price of a financial asset over a time period, the computing device further configured to compare the prediction to the actual price of the financial asset over the time period and to generate a rating of the individual based on the relationship between the prediction and actual price.

13. The system as recited in claim 12, wherein the computing device is configured to assign the individual a favorable rating when the actual price of the financial asset over the time period is consistent with the prediction.

14. The system as recited in claim 12, wherein the computing device is configured to assign the individual an unfavorable rating when the actual price of the financial asset over the time period is inconsistent with the prediction.

15. The system as recited in claim 12, wherein the computing device includes at least one of a tablet, a smartphone, a portable computer, a personal computer, and a server.

16. The system as recited in claim 12, wherein the prediction is determined by identifying at least one keyword within a social media message.

17. The system as recited in claim 16, wherein the at least one keyword includes a stock symbol and a term indicative of whether that stock will increase or decrease in price over time.

18. The system as recited in claim 12, wherein the prediction is determined by presenting the individual with at least one prompt.

19. The system as recited in claim 18, wherein the at least one prompt includes a field for the individual to enter a valid stock symbol, a field for the individual to enter a directional prediction for the stock symbol, and a field for the user to enter a time period.

20. The system as recited in claim 19, wherein the computing device is configured to construct a social media message based on entries the individual enters into the fields.
